(19) United States
(12) Patent Application Publication
(10) Pub. No.: US 2006/0022581 A1
(43) Pub. Date: Feb. 2, 2006

(54) Method for manufacturing a light emitting display

(75) Inventor: Antonius Johannes Maria Nellissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke philips Electronics N.V.

(21) Appl. No.: 10/530,302

(22) PCT Filed: Sep. 18, 2003
(86) PCT No.: PCT/IB03/04155

§ 371 Date: Apr. 4, 2005

(30) Foreign Application Priority Data
Oct. 7, 2002 (EP) 02079149.7

(51) Int. Cl. H05B 33/00; H05B 33/10; H05B 33/02

(52) U.S. Cl. 313/503; 313/506; 313/512; 427/66; 445/24

(57) ABSTRACT

The invention relates to a method for manufacturing a light emitting display comprising a plurality of light emitting elements on a substrate, wherein at least one delimiting means is provided on or over the substrate for at least partially bounding sites for deposition of a fluid light emitting substance to form the light emitting elements. At least a part of at least one of the delimiting means is repellent to the fluid light emitting substance. The repellent part may comprise a hydrophobic flow barrier. The method has the advantage of an enhanced resolution of light emitting elements, especially if the fluid light emitting substance is deposited by means of inkjet printing and involves different materials for generating different colours of light.

The invention relates to a method for manufacturing a light emitting display comprising a plurality of light emitting elements on a substrate, wherein at least one delimiting means is provided on or over said substrate for at least partially bounding sites for deposition of a fluid light emitting substance to form said light emitting elements

The invention further relates to a light emitting display and an electronic device comprising such a display.

EP-A-0 892 028 discloses an organic EL element wherein transparent pixel electrodes are formed on a transparent substrate. Photolithographically defined banks are formed between the pixel electrodes as an ink drop preventing wall.

However, the application of banks as an ink drop preventing wall may be insufficient to prevent flow of ink to adjacent parts of the structure provided as the height or thickness of the banks is limited. Moreover such banks may not meet the requirements of robustness.

It is an object of the invention to provide an improved method for manufacturing a light emitting display.

This object is achieved by providing a method for manufacturing a light emitting display characterized in that at least a part of at least one of said delimiting means is repellent to said fluid light emitting substance. By providing these repellent parts, the fluid light emitting substance can be accurately applied at the sites intended for this material. The repellent parts of the delimiting means prevent the material to flow to adjacent sites. As a result, resolution, i.e. the pitch of the adjacent sites, is enhanced. It is noted that the fluid light emitting substance can be a fluid comprising an electroluminescent material or a precursor material thereof. The fluid can e.g. be a solution, dispersion or emulsion. It can, e.g. include a soluble polymer that exhibits electroluminescence.

In a preferred embodiment of the invention the repellent part comprises a hydrophobic material. This hydrophobic material is preferably applied on a resist structure by local fluorination using a selective ion bombardment, application of a fluoropolymer or application of a water repellent primer, such as hexamethyldisilazane.

The invention can be advantageously applied for colour light emitting displays. In these types of displays different sites may comprise different light emitting materials for generating the different colours of light. These materials shall be deposited at sites that are relatively close to each other to obtain a sufficient resolution for the display, so application of the relatively narrow delimiting means or repellent parts according to the invention between these sites is advantageous for such displays.

In a preferred embodiment of the invention the fluid light emitting substance are deposited at the sites by a printing process. For such a printing process an improved edge definition or better control of the printed fluid light emitting material at the deposition sites can be obtained by using the delimiting means with the repellent parts.

It is noted that WO 00/16938 discloses a method for manufacturing a colour light-emitting display device comprising a substrate and a plurality of light emitting diode drivers for emitting light, integrated into said substrate. The substrate is covered by a transparent, hydrophobic passivation layer to enable patterning of colour changing media by wet processing in order to obtain a light emitting display with enhanced resolution. However, patterning of colour changing media is an indirect approach to enhance the resolution of the light emitting elements. Moreover colour changing media are not always applied in light emitting display devices.

The invention further relates to a light emitting display comprising a plurality of light emitting elements on a substrate, said light emitting elements being defined by sites on or over said substrate comprising light emitting materials characterized in that at least some of said sites are at least partially bounded by a hydrophobic flow barrier. This hydrophobic flow barrier is preferably applied on or over a resist structure and the display may further comprise first and second electrodes for driving the light emitting elements. Such a display may have an enhanced resolution with respect to the light emitting elements. Preferably said display is a colour display.

The invention further relates to an electric device comprising a light emitting display as described in the previous paragraph. Such an electric device may relate to handheld devices such as a mobile phone, a Personal Digital Assistant (PDA) or a portable computer as well as to devices such as a Personal Computer, a television set or a display on e.g. a dashboard of a car.

The invention will be further illustrated with reference to the attached drawing, which shows a preferred embodiment according to the invention.

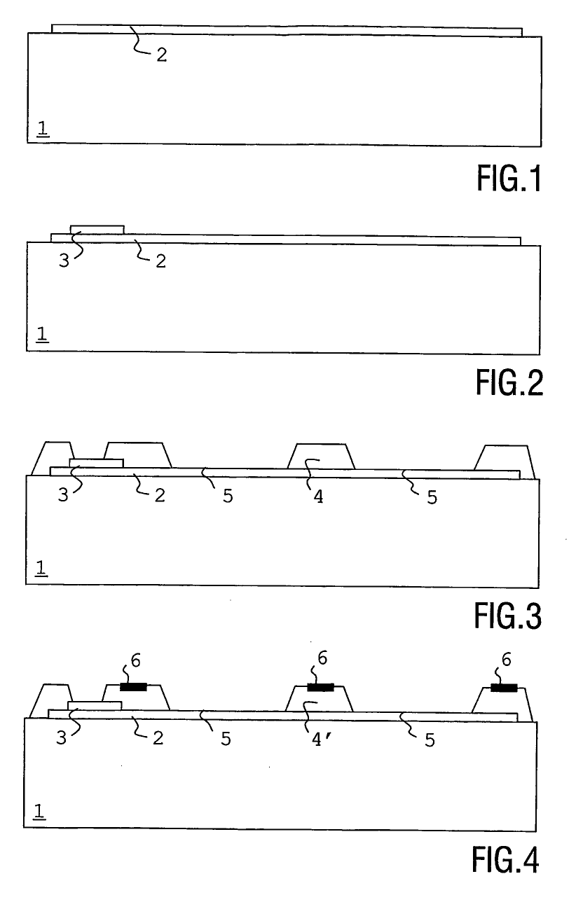

FIGS. 1-4 schematically illustrate first to fourth manufacturing steps for a light emitting display;

FIG. 5 schematically illustrates a top view at the fourth manufacturing step according to FIG. 4.

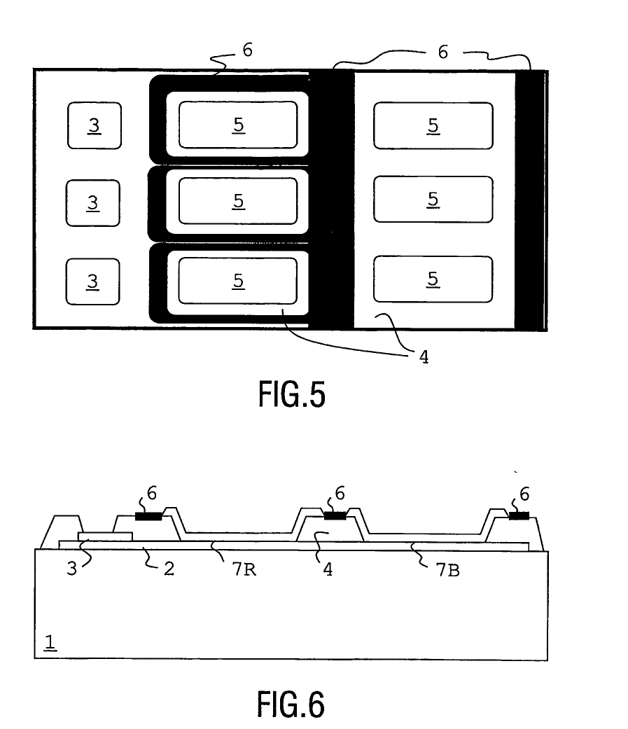

FIG. 6 schematically illustrates a fifth manufacturing step for a light emitting display;

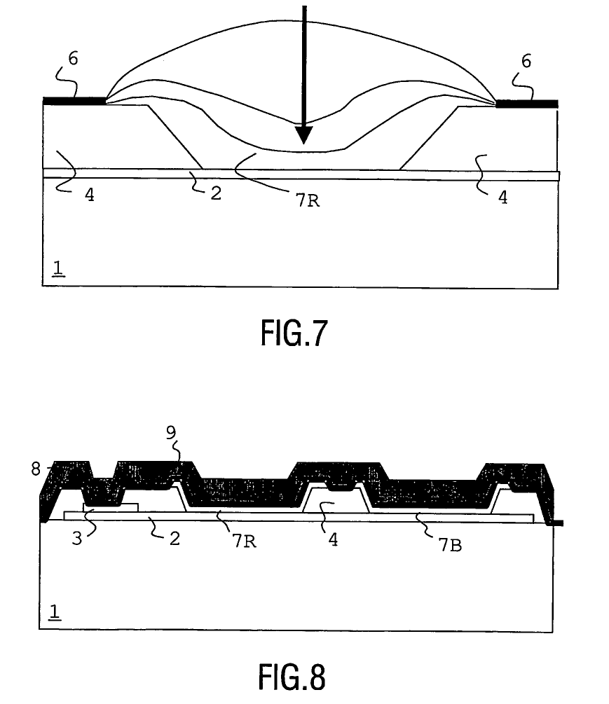

FIG. 7 schematically illustrates an enlarged view of a light emitting element during the fifth manufacturing step;

FIGS. 8-13 schematically illustrate sixth to eleventh manufacturing step for a light emitting display,

FIG. 14 schematically illustrates a light emitting display.

In FIG. 1 a substrate 1 is provided for manufacturing the light emitting display 14 (as shown in FIG. 14). Preferably, the substrate 1 is transparent with respect to the light to be emitted by the light emitting elements 7R, 7B (as shown in FIG. 6). Suitable substrate materials include synthetic resin which may or may not be flexible, quartz, ceramics and glass. The total thickness of the substrate typically ranges from 100-700 μm.

A first electrode layer 2, commonly referred to as the anode, is deposited on or over the substrate 1, e.g. by vacuum evaporation or sputtering. The first electrode layer can subsequently be patterned by photolithography. Preferably the first electrode layer 2 is transparent with respect to the light to be emitted by the light emitting elements in operation of the light emitting display 14. For example, a transparent hole-injecting electrode material, such as Indium-Tin-Oxide (ITO), is used.

In FIG. 2 a next manufacturing step is shown, wherein a low resistive metal, e.g. a Molybdenum/Aluminium/Molybdenum (MAM) layer 3 is deposited on or over the first electrode layer 2. The MAM layer 3 is subsequently defined photolithographically, e.g. at the positions where no light is to be generated. MAM layer 3 is applied for contacting purposes and for decreasing the electrical resistance to the first electrode layer 2. The total thickness of MAM layer 3 typically ranges up to 0.5 μm.

In FIG. 3 a next manufacturing step is shown, wherein an insulating layer, such as novolack or acrylate, is spincoated over the structure shown in FIG. 2 and is subsequently patterned by means of photolithography. The insulating layer is e.g. baked at 220° C. for 30 minutes. In patterning the insulating layer delimiting means 4 define cavities or sites 5 between the delimiting means 4 for the light emitting elements 7R and 7B to be deposited further on. Moreover the delimiting means 4 assists in the separation of the second electrode layer as will be described in more detail below. The widths of the delimiting means 4 is typically 20 cm with a thickness of about 3 μm. The insulating layer or delimiting means 4 is of a hydrophilic nature, i.e. it may exert an attractive force on liquid state materials.

In FIG. 4 a next manufacturing step is shown wherein parts 6, repelling the fluid light emitting substance to be deposited afterwards are applied on or over the delimiting means 4, bounding the sites 5 of the light emitting elements. The repelling parts may e.g. be strips of repelling material. These repelling parts 6 may be obtained in various ways. A first way is to apply a layer of resist material (not shown) on or over the structure shown in FIG. 3 by spincoating and subsequently define the places where the repelling parts means are to be positioned photolithographically. Next the structure may be exposed to a CF4 treatment to fluorinate the defined places by a selective ion bombardment to obtain the repelling parts 6 of hydrophobic nature. Finally the resist material is removed. Alternatively a photopolymer is applied and photolithographically patterned that contains hydrophobic compounds. In this way no CF4 treatment is necessary to provide the hydrophobic property. In yet another alternative a hydrophobic primer such as HDMS (hexamethyldisilazane) is applied. First a monomolecular layer of HMDS may be applied in a vacuum oven at 120° C. followed by spincoating of a photoresist material. Next the structure is pattern wise exposed to a UV source, after which the exposed structure is developed followed by partial removal of the HMDS primer such that the repelling parts or strips 6 remain under the photoresist layer. Finally the photoresist layer is removed in a solvent, e.g. acetone, that does not attack the HMDS layer. The width of the repellent part may range from 5-15 μm, e.g. 10 μm.

FIG. 5 shows a top view of a part of the light emitting display after the repelling parts 6 have been applied. In FIG. 5 it is illustrated that the repelling parts 6 can be applied to bound the cavities or sites 5 in a number of ways. FIG. 5 shows as examples bounding by the repelling parts 6 along the entire circumference of the sites 5 (left-hand column of cavities or sites 5) and a partial bounding by the repelling parts 6 (right-hand column of cavities or sites 5). The way in which the repelling parts 6 bound the sites 5 may be dependent on the process chosen for deposition of the fluid light emitting substance or the arrangement of colours for the various cavities or sites 5. If e.g. the same colour is to be deposited in a column, repelling parts 6 that only partially bound the sites 5, according to the right-hand column of FIG. 5, may be used, since flow of material between the sites 5 in this column may not be harmful.

In FIG. 6 a next manufacturing step is shown, wherein the fluid light emitting substance is deposited in the cavities or at the sites 5 to obtain the light emitting elements 7. It is noted that a light emitting element 7 may comprise several conductive polymer layers, such as a polyethylenedioxythiophene (PEDOT) layer and a polyphenylenevinylene (PPV). For a colour light emitting display different materials may be used. In FIG. 6 light emitting element 7R refers to a red-light emitting material and light emitting element 7B refers to a blue light emitting material. Conventionally a third material G emitting green light is applied as well. The light emitting materials R, G and B are preferably electroluminescent materials and are deposited by inkjet-printing. The length of a light emitting element is e.g. 240 μm.

FIG. 7 shows a detailed view of a cavity or site 5, wherein the fluid red light emitting substance has been deposited and is depicted in various stages of the drying process after deposition. Due to evaporation of the solvents used, shrinkage, indicated by the arrow, occurs leaving the red light emitting material behind in the cavity or site 5. The red light emitting material layer is necessarily somewhat oversized with respect to the site 5 to avoid shortcuts emanating if the light emitting display is operated, i.e. a voltage is applied over the light emitting layer. The oversized red light emitting material is obtained, since the insulating layer 4 or delimiting means 4′ is of a hydrophilic nature.

However, the fluid light emitting substance of light emitting element 7R should not flow to an adjacent light emitting element 7B comprising a light emitting of different colour. It is illustrated that this effect is achieved by employing hydrophobic barriers as repelling parts 6.

In FIG. 8 a next manufacturing step is shown wherein metallization is applied on or over the light emitting elements 7R and 7B. This metallization consists e.g. of a barium layer 8′ for reducing the barrier level for injecting electrons, on top of which a second electrode layer 9, commonly referred to as the cathode, is deposited. However, in the manufacturing process applied here an additional molybdenum or titanium layer 8″ is applied, acting as a diffusion barrier for protecting the light emitting elements 7R and 7B for wet etching solutions. In FIG. 8 the barium layer 8′ and the titanium or molybdenum layer 8″ are shown as a single layer 8. The thickness of the barium layer 8′ is e.g. 5 nm, of the titanium or molybdenum layer 8″ e.g. 100 nm and of the cathode layer 9 e.g. 2 μm. Prior art cathode layers have a thickness of about 0.5 μm maximum. As a result of the thick cathode layer 9 in this embodiment of the invention, the electrical resistance for applying a voltage to the light emitting element 7 has significantly decreased.

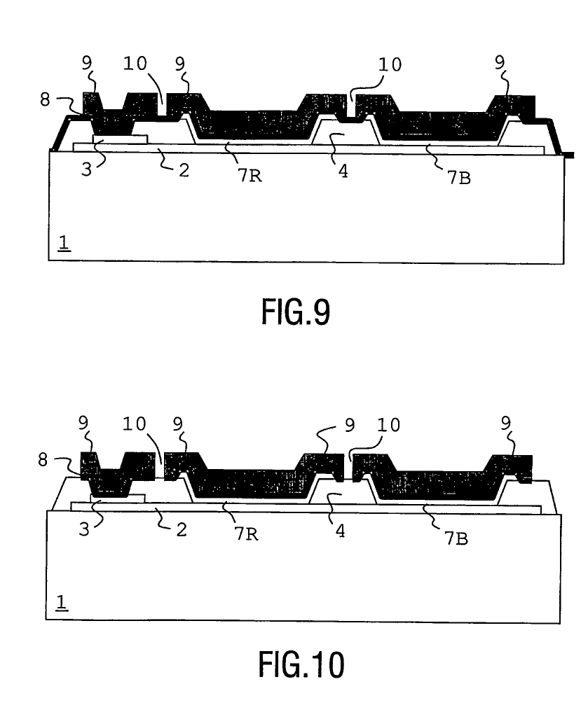

In FIG. 9 a next step of the manufacturing process is shown, wherein the cathode layer 9, is patterned. Cathode layer 9 is made of e.g. aluminium. Patterning of the cathode layer 9 is performed by photolithography followed by wet etching recesses 10 in the cathode layer 9. The wet etching process does not affect the light emitting elements 7R and 7B, since the titanium layer or molybdenum layer 8″ acts as a diffusion barrier to the wet etching means. For etching of aluminium a mixture of e.g. acetic acid, phosphoric acid, and nitric acid may be used.

In FIG. 10 a next manufacturing process step is shown, wherein the layer 8 is partially removed at the recesses 10 by plasma etching in a CF4/Ar environment.

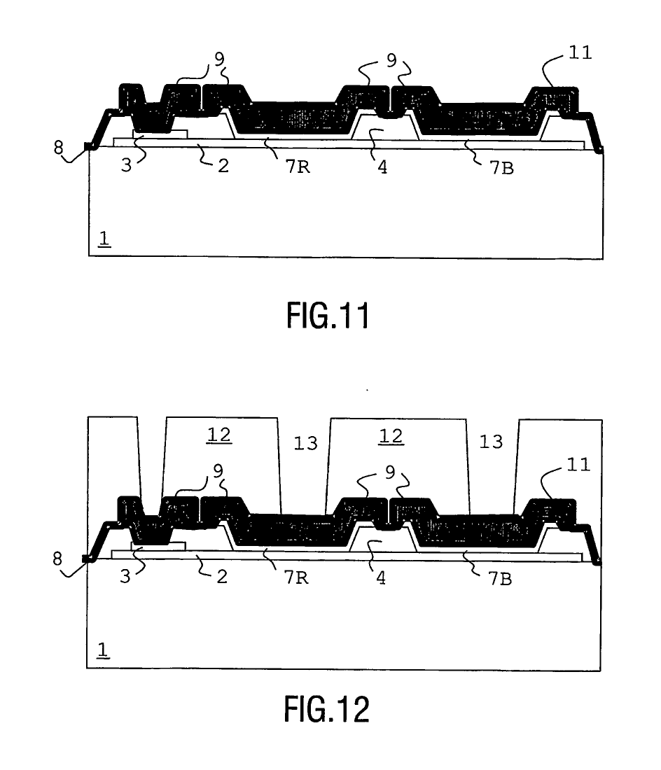

In FIG. 11 a next manufacturing process step is shown, wherein a SiN layer 11 is deposited over the structure shown in FIG. 10. This layer 11 hermetically seals the structure from liquid or moisture that may affect the light emitting layers or elements 7R and 7B, e.g. via the recesses 10. It is noted that the manufacturing process steps shown in FIG. 10 and 11 may be performed in combination by using a cluster tool. In this case the structure is not exposed to air between etching of the diffusion barrier and hermetic sealing with SiN. The SiN layer 11 has a thickness of e.g. 0.5 μm.

In FIG. 12 a next manufacturing process step is shown, wherein a protection layer 12 is applied on or over the structure shown in FIG. 11. This protection layer 12 is obtained e.g. by spincoating a resist or by laminating a dry film resist and has a thickness of e.g. 10 μm. Recesses 13 can be obtained by photolithography. The resist 12 is e.g. baked at 120° C. for 30 minutes.

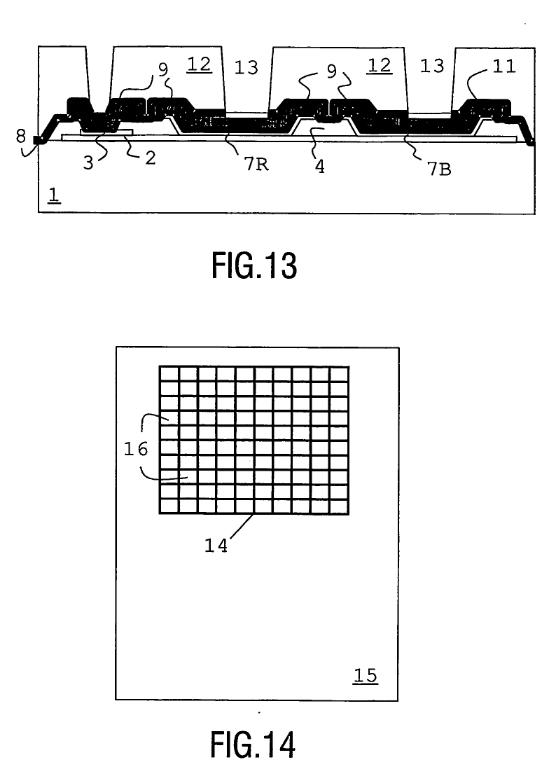

In FIG. 13 a final manufacturing process step is shown, wherein the SiN layer 11 has been partially removed at the positions where the cathode layer 9 is to be contacted by connecting leads for operating the light emitting display. SiN layer 11 may e.g. be removed in a CF4 plasma.

In FIG. 14 a light emitting display 14, which may be a polymer or small molecule light emitting diode device, is depicted as a part of an electric device 15. The light emitting display 14 is e.g. a colour display comprising display pixels 16 arranged in a matrix of rows and columns comprising red, green and blue light emitting elements 7R, 7G and 7B.

These light emitting elements may be light emitting diodes. It is noted that the light emitting elements 7R, 7G and 7B may be arranged in several configurations to form a display pixel 16, such as a rectangular or a triangular configuration. The light emitting elements 7R and 7B can be operated by applying signals to the anode 2 and/or cathode 9 in an appropriate manner.

For the purpose of teaching the invention, a preferred embodiment of a method for manufacturing a light emitting display has been described above. It will be apparent for the person skilled in the art that other alternative and equivalent embodiments of the invention can be conceived and reduced to practice without departing from the true spirit of the invention, the scope of the invention being only limited by the claims.

1. Method for manufacturing a light emitting display comprising a plurality of light emitting elements on a substrate, wherein at least one delimiting means is provided on or over said substrate for at least partially bounding sites for deposition of a fluid light emitting substance to form said light emitting elements characterized in that at least a part of at least one of said delimiting means is repellent to said fluid light emitting substance.

2. Method according to claim 1, wherein said repellent part comprises a hydrophobic material.

3. Method according to claim 2, wherein said sites are bounded by a resist structure and the repellent parts are applied on said resist structure by local fluorination, application of a fluoropolymer or application of a water repellent primer.

4. Method according to claim 3, wherein said water repellent primer is hexamethyldisilazane.

5. Method according to claim 1, wherein different fluid light emitting substances adapted to generate different colours of light are deposited at different sites.

6. Method according to claim 1, wherein said fluid light emitting substance is deposited at said sites by a printing process.

7. Light emitting display comprising a plurality of light emitting elements on a substrate, said light emitting elements being defined by sites on or over said substrate comprising light emitting materials characterized in that at least some of said sites are at least partially bounded by a hydrophobic flow barrier.

8. Light emitting display according to claim 7, wherein said hydrophobic flow barrier is applied on or over a resist structure and said display further comprises first and second electrodes for driving said light emitting elements.

9. Light emitting display according to claim 7, wherein said display is a colour display.

10. Electric device comprising a light emitting display according to claim 7.
